(19) United States
(12) Patent Application Publication
(10) Pub. No.: US 2015/0293763 A1
(43) Pub. Date: Oct. 15, 2015

(54) DYNAMIC AND INTELLIGENT MULTI-TRIGGERED ITEM REVALIDATION BASED ON PROJECTED RETURN ON INVESTMENT

(71) Applicant: International Business Machines Corporation, Armonk, NY (US)

(72) Inventors: Trudy L. Hewitt, Cary, NC (US); Joseph Lam, Markham (CA); Natasha P. Lishok, Cary, NC (US); William K. Wentworth, Round Rock, TX (US)

(21) Appl. No.: 14/637,092

(22) Filed: Mar. 3, 2015

Related U.S. Application Data
(63) Continuation of application No. 14/250,246, filed on Apr. 10, 2014.

(51) Int. Cl. G06F 9/44; H04L 29/08

(52) U.S. Cl. CPC G06F 8/70; H04L 67/10; H04L 67/06

(57) ABSTRACT

Provided are techniques for item revalidation based on projected Return On Investment (ROI). In response to one or more triggers, an amount of time that it would take to update an item and a return on investment of updating the item are estimated based on historical data for similar updates that have been made to at least one of the item and another item, and it is determined whether to update the item based on the estimated amount of time and the estimated return on investment.

### BACKGROUND

Embodiments of the invention relate to dynamic and intelligent multi-triggered item revalidation based on projected Return On Investment (ROI).

Systems today allow storage of a large number of documents in a repository. For example, an administrator may manage 80,000 documents in the repository, and the number of documents in that repository continues to increase. To ensure that documents are reviewed on a periodic basis for effectiveness and relevancy, the documents are set to be re-reviewed at regular intervals manually by the administrator. However, that review requirement is based on time. Thus, all documents are reviewed, even if only certain documents need to be reviewed.

### SUMMARY

Provided is a method for item revalidation based on projected ROI. The method comprises: in response to one or more triggers, estimating, using a processor of a computer, an amount of time that it would take to update an item and a return on investment of updating the item based on historical data for similar updates that have been made to at least one of the item and another item, and determining whether to update the item based on the estimated amount of time and the estimated return on investment.

Provided is a computer program product for item revalidation based on projected ROI. The computer program product comprises a computer readable storage medium having program code embodied therewith, the program code executable by at least one processor to perform: in response to one or more triggers, estimating, by the processor, an amount of time that it would take to update an item and a return on investment of updating the item based on historical data for similar updates that have been made to at least one of the item and another item, and determining, by the processor, whether to update the item based on the estimated amount of time and the estimated return on investment.

Provided is a computer system for item revalidation based on projected ROI. The computer system comprises one or more processors, one or more computer-readable memories and one or more computer-readable, tangible storage devices; and program instructions, stored on at least one of the one or more computer-readable, tangible storage devices for execution by at least one of the one or more processors via at least one of the one or more memories, to perform: in response to one or more triggers, estimating an amount of time that it would take to update an item and a return on investment of updating the item based on historical data for similar updates that have been made to at least one of the item and another item, and determining whether to update the item based on the estimated amount of time and the estimated return on investment.

### BRIEF DESCRIPTION OF THE SEVERAL VIEWS OF THE DRAWINGS

Referring now to the drawings in which like reference numbers represent corresponding parts throughout:

FIG. 1 illustrates, in a block diagram, a computing environment in accordance with certain embodiments.

FIG. 2 illustrates, in a flow diagram, operations for determining whether to revalidate an item in an item repository in accordance with certain embodiments.

FIG. 3 illustrates a workflow example in accordance with certain embodiments.

FIG. 4 illustrates a cloud computing node in accordance with certain embodiments.

FIG. 5 illustrates a cloud computing environment in accordance with certain embodiments.

FIG. 6 illustrates abstraction model layers in accordance with certain embodiments.

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

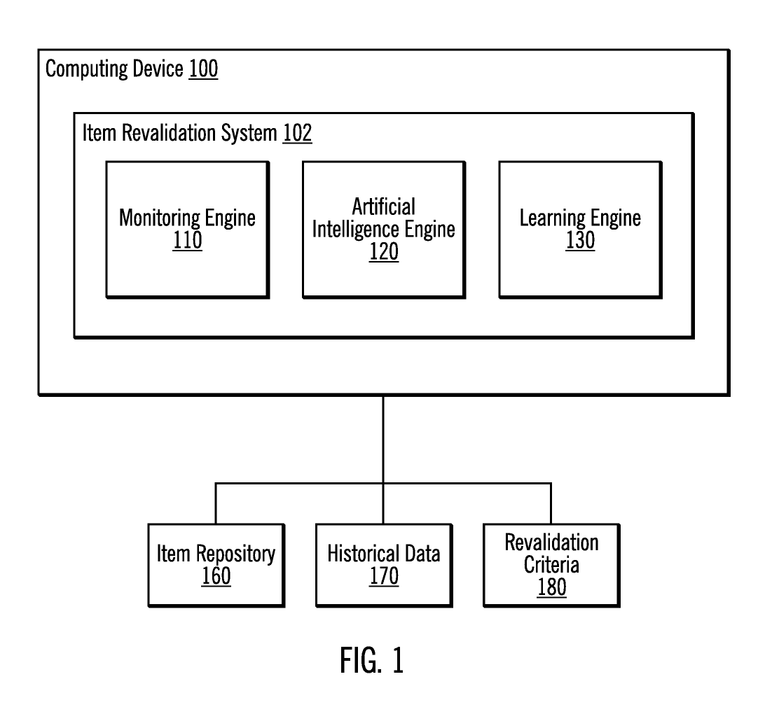

FIG. 1 illustrates, in a block diagram, a computing environment in accordance with certain embodiments. A computing device 100 includes an item revalidation system 102, which includes a monitoring engine 110, an artificial intelligence engine 120, and a learning engine 130. The computing device 100 is coupled to an item repository 160, historical data 170 (e.g., past data), and revalidation criteria 180 (e.g., rules). In various embodiments, the item repository 160, historical data 170, and revalidation criteria 180 may be in the same or separate physical repositories.

Each item in the item repository 160 may be a document, video, audio, web pages, blogs, etc.

The monitoring engine 110 determines whether an item in the item repository 160 has met one or more of the revalidation criteria 180 that triggers revalidation. Revalidation may be described as determining whether to update an item. For example, revalidation may also be described as determining what updates may be made to a broader body of content based on projections to increase the value of that content when updated. The artificial intelligence engine 120 evaluates content of an item and determines whether a projected Return On Investment (ROI) is greater than a projected amount of time to update (e.g., add to, remove from, edit, re-format, etc.) the item. The learning engine 130 gathers information on what changes are made (either by the user or dynamically by the item revalidation system 102 and monitors the changes in activity/value to determine whether the projected ROI is accurate and, if not accurate, take this into consideration for future projections.

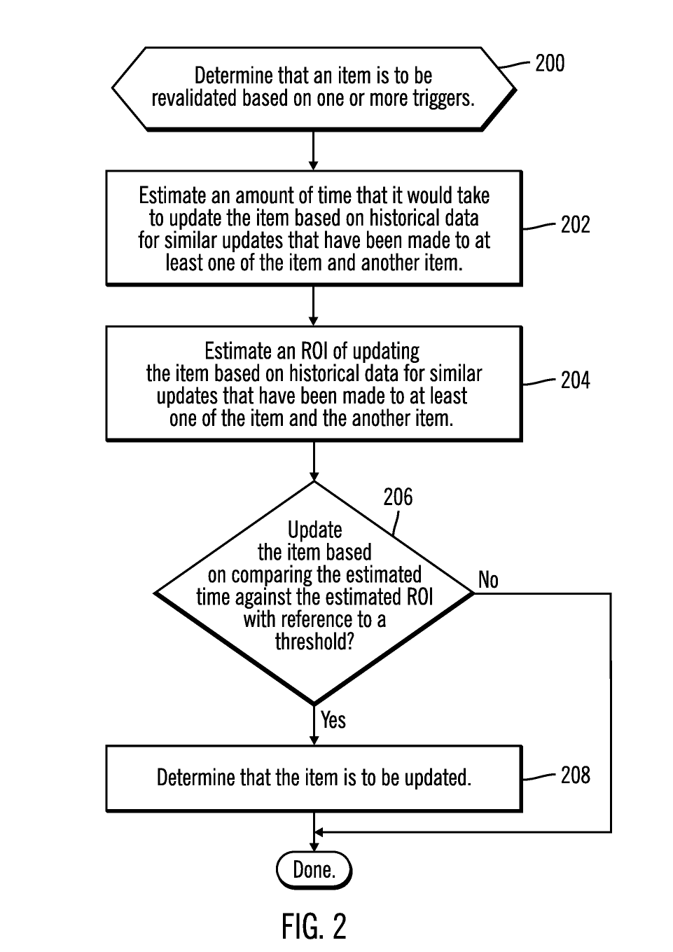

The item revalidation system 102 dynamically determines, using multiple triggers, whether the value of an item may be increased by making one or more updates to the content or retention date of the item. FIG. 2 illustrates, in a flow diagram, operations for determining whether to revalidate an item in the item repository in accordance with certain embodiments. Control begins at block 200 with the item revalidation system 102 determining that an item is to be revalidated based on one or more triggers. The one or more triggers are based on the revalidation criteria. The processing of FIG. 2 may be performed periodically for all or a subset of the items in the item repository 160.

In block 202, the item revalidation system 102 estimates an amount of time that it would take to update the item based on historical data for similar updates that have been made to at least one of the item and another item. The updates may be to content of the item and/or a retention date of the item. Updating the retention date causes the item to be retained in the item repository to that retention date. In various embodiments, the content of the item may refer to a portion of the item or the entire item. In block 204, the item revalidation system 102 estimates an ROI of updating the item based on historical data for similar updates that have been made to at least one of the item and another item. In certain embodiments, the ROI may be described as a projected increase in value (e.g., increased number of accesses, improved customer statistics, etc.). In various embodiments, the historical data used in blocks 202 and 204 may be the same historical data or different historical data (e.g., having different information).

In block 206, the item revalidation system 102 determines whether to update the item based on comparing the estimated time against the estimated ROI. That is, based on the comparison, the item revalidation system 120 determines whether the ROI of time spent is worth the value increase for the item to be updated with reference to a threshold. If so, processing continues to block 208, otherwise, processing is done. In certain embodiments, an administrator or user provides predefined rules or preferences for what would be considered a high return on investment and worth the time for updating, and this is used to set the threshold. For example, an administrator or use may predefined that updates that take X amount of time need to meet a minimum threshold of X % increase in value (e.g., accesses, improved feedback, etc.) in order for the item revalidation system 120 to take the action. In various embodiments, the amount of time may be a calculation of either 1) the CPU usage time it would take or 2) manual amount of time that it would require a user to update it. In block 208, the item revalidation system 102 determines that the item is to be updated. In certain embodiments, with the processing of block 208, the item revalidation system 102 may also update the item by at least one of updating the content of the item and updating a retention date of the item. The processing of block 208 may include notifying the owner of the item that the item is to be updated. If the item revalidation system 102 determines that it is not worth updating the item, then the owner of the item is not notified and does not spend unnecessary time updating that item. As an example, if the item revalidation system 102 determines that it is not worth updating the item, the retention date of that item is not updated, and the item may then be removed from the item repository 160 or otherwise processed at the retention date. Also, in some embodiments, in response to determining that the item is to be revalidated, the item revalidation system 102 identifies another, similar item to be revalidated.

The item revalidation system 102 may be implemented using an artificial intelligence engine 120 that would use a dynamic, multi-faceted, revalidation approach to determine whether a piece of content continues to be relevant using configurable statistics (e.g., number of accesses, number of unique users, a 5 star rating, document level feedback (positive or negative sentiment), etc.) as well as other factors (e.g., is effective in addressing customer issues, in helping customers solve problems, in providing interesting information, etc.). The item revalidation system 102 analyzes access metrics and references from other items to extrapolate whether a piece of content is relevant. Based on that information, the item revalidation system 102 determines whether the item should be, for example, republished when the item reaches its pre-determined expiration date. The item revalidation system 102 uses multiple factors to determine whether the piece of content is effective and needs to remain in the published repository.

The following is a non-limiting, non-exhaustive list of examples of triggers (which may also be referred to as tasks or factors) that the artificial intelligence engine 120 may include:
Analysis of a search engine ranking of this item in popular search engines.
Analysis of the search engine ranking of items with similar keywords that are published across the Internet by both the same company and competitors.
Analysis of access trends for the item and similar items over periods of time (e.g., 1, 3, 6, and 12 months) to determine whether the topic is still relevant.
Determination of when the content of the item was last updated and whether newer product versions exist that contain the same functionality, but that are not referenced in the item.
Determination of when a product and associated releases for the item are scheduled to go out of support.
Searching of social media channels (e.g., blogs, forums, and other social media sites for sharing photos and comments) to determine whether topics in the item are referenced.
Searching for other items across the Internet that reference the item.
Reviewing any relevant customer feedback for the item and using its categorical positive and negative data in determining the item's effectiveness.
Completing a cost benefit analysis of the support costs that are incurred in answering questions on topics covered by the item in communications with customers.
Determination of the frequency that a question on a topic covered by the item is asked and generation of a percentage of likelihood that the topic will re-emerge from another customer.

The item revalidation system 102 may utilizes data gathered (from the above example sources) in its evaluation of whether the triggers should initiate a revalidation. After the item revalidation system 102 has identified that revalidation would improve the value of the content, the item revalidation system 102 would then project out the amount of time it would take to update the content (e.g., looking at historical data for past updates that have been made to similar content) and the cause/effect that those updates had on increasing the value of that content (e.g., # of accesses, improved customer statistics, etc.). Using that data, the item revalidation system 102 would determine whether the ROI of time spent is worth the value increase for the item to be updated.

In certain embodiments, information gathered for each item is fed into the learning engine 130 that the artificial intelligence engine 120 would then use/consider for future revalidations as to which topics are relevant and, in turn, increase the speed in determining which items should continue to be available in the repository.

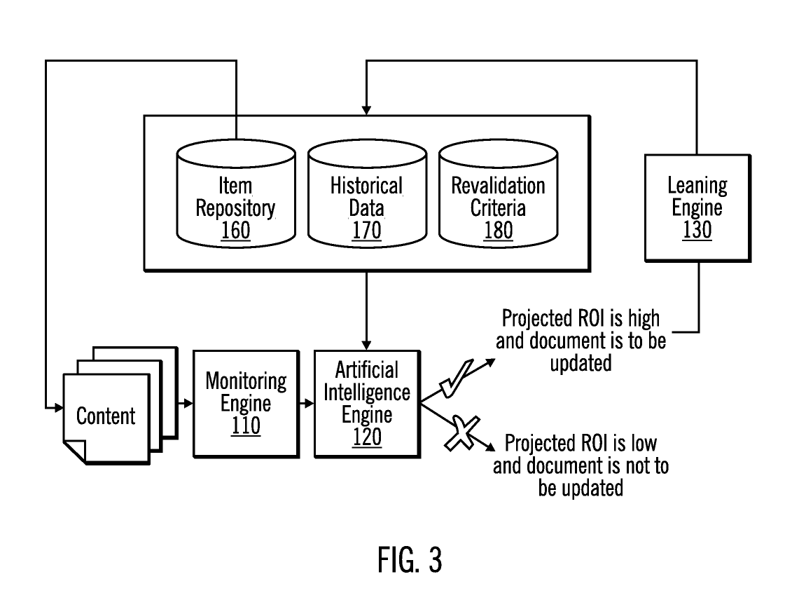

FIG. 3 illustrates a workflow example in accordance with certain embodiments. In this example, the item repository 160 contains information and details on content (e.g., in an item) and similar content (e.g., in another item) used for evaluation. The historical data 170 includes analytics data on content, such as dates, update activity, access activity, ratings, etc. The revalidation criteria 180 includes rules for triggering a check on whether to perform revalidation and thresholds for what minimum ROI would be needed to identify an item as one to be revalidated. The monitoring engine 110 determines whether an item has met one or more of the revalidation criteria 180 and is to be checked for revalidation. When the item is to be checked, the artificial intelligence engine 120 determines whether the ROI is greater than a projected time amount of time to update the item. If so, the item may be updated by the item revalidation system 102 or may besent to the owner of the item for revalidation, otherwise, the item is not revalidated (e.g., not sent to the owner of the item for revalidation). In addition, the learning engine 130 stores information based on the output of the artificial intelligence engine 120. For example, if a user changes an acronym to the full text/name of a product, which results in an increase in accesses, the item revalidation system 102 may scan for other instances of that acronym and calculate the ROI (how long it would take versus the increased percentage (%) of value). If the ROI is seen to be high, the item revalidation system 102 may either make the updates automatically or recommend to the item owner to make the updates.

Merely to enhance understanding of embodiments, some use case scenarios are presented herein. In a first use case scenario, a user updates a product acronym from WAS to WebSphere Application Server, which results in increased accesses. The item revalidation system 102 scans the item repository for other similar/related items to identify the amount of work effort that would be required to make the change in other items (either manual effort by user and/or automated CPU usage or other work effort) and uses the historical data to project the ROI of making broader changes to the item repository. The ROI is compared against the threshold ROI set in the revalidation criteria to determine whether an action (i.e., some form of revalidation) should be performed.

In a second use case scenario, a user changes in the content the full product name (i.e. WebSphere Application Server) to the acronym, WAS, which results in a decrease in accesses. The item revalidation system 102 detects the decrease in accesses/ROI and initiates the change to have the acronym reverted back to the full product name. In addition, the item revalidation system 102 identifies the amount of work effort that would be required to make the change in other items in which the acronym is being used as opposed to the full name and compares a projected ROI against the threshold set in the revalidation criteria to determine whether an action (i.e., some form of revalidation) should be performed for broader changes to the item repository.

In a third use case scenario a user replaces a long form Uniform Source Locator (URL) in a document with canonical URL (short form) to another related document, which results in increased accesses for the document being linked to. The item revalidation system 102 scans the item repository for other long form URLs to determine whether others may be simplified and projects the work effort (either manual effort by user and/or automated CPU usage or other work effort) to make the changes and projects the ROI of making changes to the other applicable content in the item repository. The projection is compared against the threshold set in the revalidation criteria to determine whether an action (i.e., some form of revalidation) should be performed.

In a fourth use case scenario, a user inserts a short hands-on video into a how-to document, which results in an increase in accesses and customer satisfaction for the item. The item revalidation system 102 scans item repository for other items with a similar item goal and content structure to determine whether the other items should have an accompanying video demo and projects the ROI of making this change to the other applicable content in the item repository. The projection would be compared against the threshold set in the revalidation criteria to determine whether an action (i.e., some form of revalidation) should be performed.

In a fifth use case scenario, a user updates a best practice item with information for a new version of the product, which results in an increase in web accesses and a higher search engine ranking. The item revalidation system 102 scans the item repository for other items with the same product in the taxonomy to determine whether the other items should be updated with information that is pertinent to the new version of the product and projects the ROI of making this change to the other applicable content in the item repository. The projection would be compared against the threshold set in the revalidation criteria to determine whether an action (i.e., some form of revalidation) should be performed.

In a sixth use case scenario, a template is introduced that causes the bullets to be out of alignment from the original authored item. A user/author edits the item to manually correct the alignment. However, the item revalidation system 102 detects no change to the value or ROI based on this work effort. Based on the projected low ROI, no other changes are instigated to other content in the item repository.

Thus, the item revalidation system 102 is able to compile data and use that data to dynamically evaluate content based on multiple factors. The item revalidation system 102 may use that data to make decisions on whether an item should continue to be available to solve customer issues by updating the retention date of the item. The item revalidation system 102 is dynamic, unlike existing solutions that use static and/or fixed rules for determining whether an item should be revalidated. The item revalidation system 102 increases the value of content; while decreasing the amount of time spent making updates to content that will have little to no impact (improvement) on the value of content. The item revalidation system 102 is helpful in limiting the amount of content that is available while not overwhelming storage resources.

The item revalidation system 102 may be used for intelligent item revalidation based on the projected ROI. However, the item revalidation system 102 may also be used for other forms of content sources, including but not limited to video, audio, web pages, blogs, etc.

With embodiments, an administrator (or owner of an item) may be provided with documents selected for review based on artificial intelligence so that just those documents that need to be reviewed are reviewed. This eliminates the time spent to unnecessarily review content that does not need to be reviewed (as determined by artificial intelligence).

Embodiments take into account the amount of effort required update content and the benefits that can be derived from those updates to determine whether the content should be revalidated. In particular, embodiments provide a content revalidation process based on business intelligence, and the calculation of the ROI to determine whether content should be updated, republished with the updates or archived. Embodiments estimate the amount of time it would take to make an update to a document, and compare that amount of time against the projected increase in value to determine whether the ROI is worthwhile for the update to take place. Embodiments provide a dynamic way to revalidate and manage content based on business analytics, artificial intelligence, and calculated ROI. Embodiments estimate the amount of time it would take to make updates to content and compare this time against the projected increase in value, in the form of access metrics, improved customer satisfaction, Net Satisfaction Index (NSI) (which is a measurement used to determine how satisfied a customer is with documents, with a product/service, etc.), to determine whether the effort of updating is worth the increase in value of updating that document.

Thus, embodiments enable intelligent/dynamic content revalidation/updates based on projected ROI (increase/decrease value vs. time investment in content updates).

### Cloud Computing

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

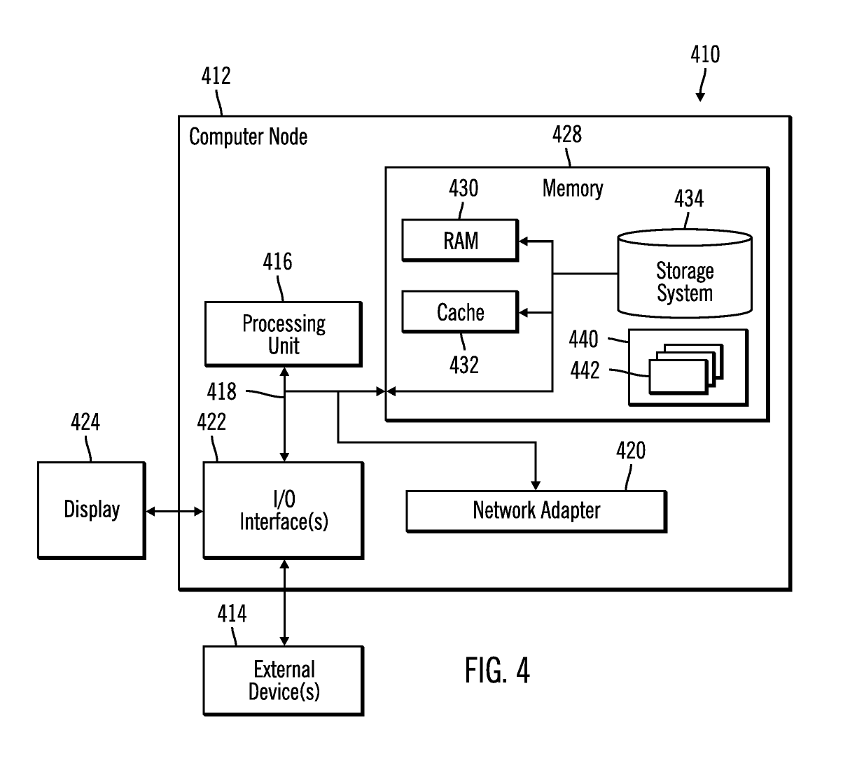

Referring now to FIG. 4, a schematic of an example of a cloud computing node is shown. Cloud computing node 410 is only one example of a suitable cloud computing node and is not intended to suggest any limitation as to the scope of use or functionality of embodiments of the invention described herein. Regardless, cloud computing node 410 is capable of being implemented and/or performing any of the functionality set forth hereinabove.

In cloud computing node 410 there is a computer system/server 412, which is operational with numerous other general purpose or special purpose computing system environments or configurations. Examples of well-known computing systems, environments, and/or configurations that may be suitable for use with computer system/server 412 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 412 may be described in the general context of computer system executable instructions, such as program modules, being executed by a computer system. Generally, program modules may include routines, programs, objects, components, logic, data structures, and so on that perform particular tasks or implement particular abstract data types. Computer system/server 412 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 4, computer system/server 412 in cloud computing node 410 is shown in the form of a general-purpose computing device. The components of computer system/server 412 may include, but are not limited to, one or more processors or processing units 416, a system memory 428, and a bus 418 that couples various system components including system memory 428 to processor 416.

Bus 418 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 412 typically includes a variety of computer system readable media. Such media may be any available media that is accessible by computer system/server 412, and it includes both volatile and non-volatile media, removable and non-removable media.

System memory 428 can include computer system readable media in the form of volatile memory, such as random access memory (RAM) 430 and/or cache memory 432. Computer system/server 412 may further include other removable/non-removable, volatile/non-volatile computer system storage media. By way of example only, storage system 434 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 418 by one or more data media interfaces. As will be further depicted and described below, memory 428 may include at least one program product having a set (e.g., at least one) of program modules that are configured to carry out the functions of embodiments of the invention.

Program/utility 440, having a set (at least one) of program modules 442, may be stored in memory 428 by way of example, and not limitation, as well as an operating system, one or more application programs, other program modules, and program data. Each of the operating system, one or more application programs, other program modules, and program data or some combination thereof, may include an implementation of a networking environment. Program modules 442 generally carry out the functions and/or methodologies of embodiments of the invention as described herein.

Computer system/server 412 may also communicate with one or more external devices 414 such as a keyboard, a pointing device, a display 424, etc.; one or more devices that enable a user to interact with computer system/server 412; and/or any devices (e.g., network card, modem, etc.) that enable computer system/server 412 to communicate with one or more other computing devices. Such communication can occur via Input/Output (I/O) interfaces 422. Still yet, computer system/server 412 can communicate with one or more networks such as a local area network (LAN), a general wide area network (WAN), and/or a public network (e.g., the Internet) via network adapter 420. As depicted, network adapter 420 communicates with the other components of computer system/server 412 via bus 418. It should be understood that although not shown, other hardware and/or software components could be used in conjunction with computer system/server 412. Examples, include, but are not limited to: microcode, device drivers, redundant processing units, external disk drive arrays, RAID systems, tape drives, and data archival storage systems, etc.

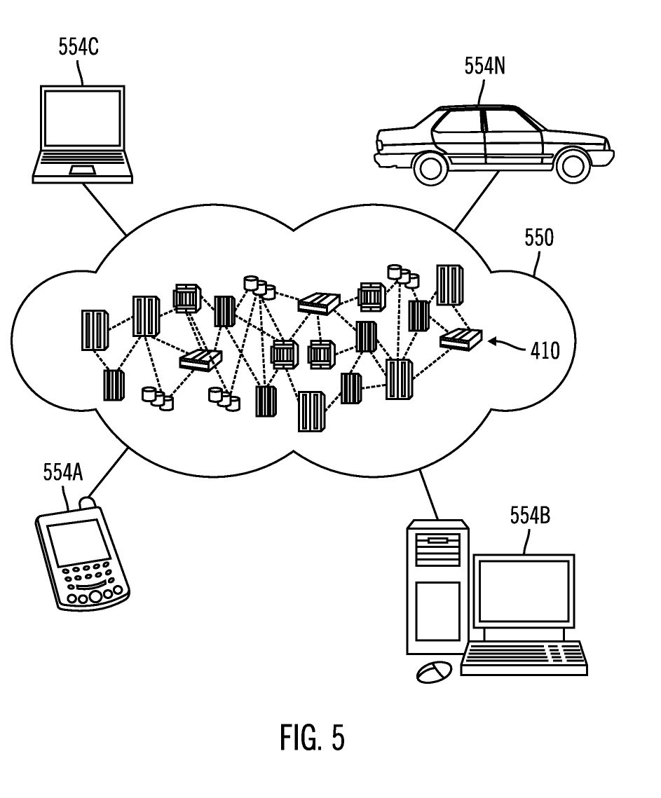

Referring now to FIG. 5, illustrative cloud computing environment 550 is depicted. As shown, cloud computing environment 550 comprises one or more cloud computing nodes 410 with which local computing devices used by cloud consumers, such as, for example, personal digital assistant (PDA) or cellular telephone 554A, desktop computer 554B, laptop computer 554C, and/or automobile computer system 554N may communicate. Nodes 410 may communicate with one another. They may be grouped (not shown) physically or virtually, in one or more networks, such as Private, Community, Public, or Hybrid clouds as described hereinabove, or a combination thereof. This allows cloud computing environment 550 to offer infrastructure, platforms and/or software as services for which a cloud consumer does not need to maintain resources on a local computing device. It is understood that the types of computing devices 554A-N shown in FIG. 5 are intended to be illustrative only and that computing nodes 410 and cloud computing environment 550 can communicate with any type of computerized device over any type of network and/or network addressable connection (e.g., using a web browser).

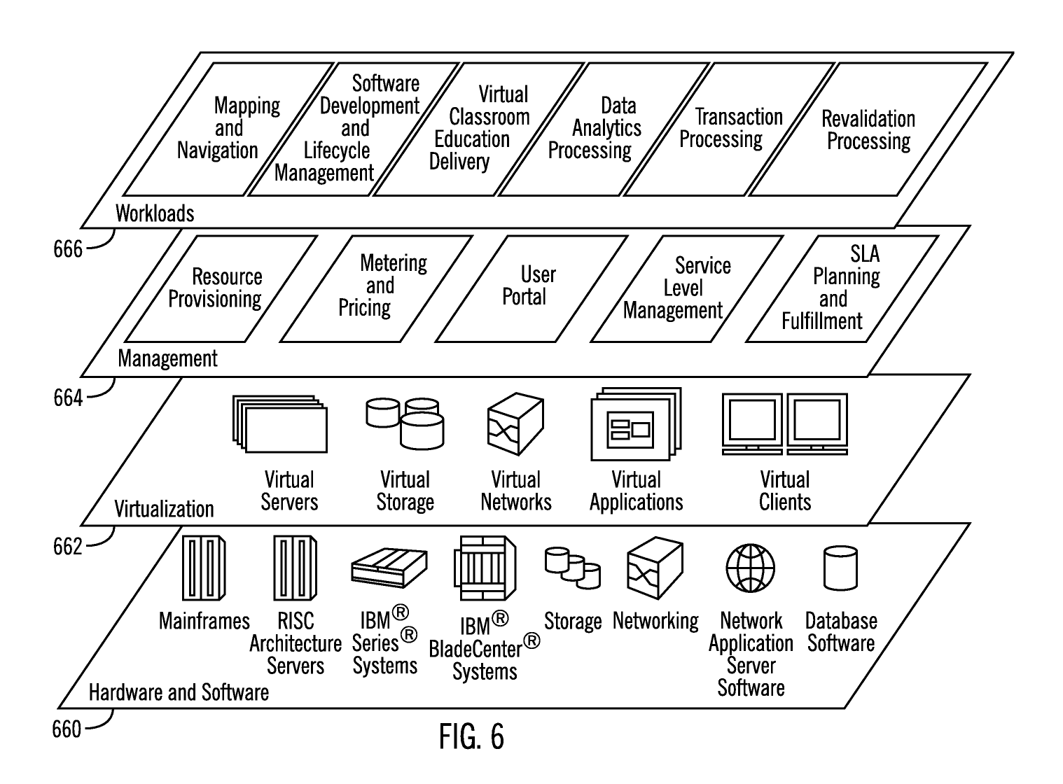

Referring now to FIG. 6, a set of functional abstraction layers provided by cloud computing environment 550 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 660 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 662 provides an abstraction layer from which the following examples of virtual entities may be provided: virtual servers; virtual storage; virtual networks, including virtual private networks; virtual applications and operating systems; and virtual clients.

In one example, management layer 664 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 666 provides examples of functionality for which the cloud computing environment may be utilized. Examples of workloads and functions which may be provided from this layer include: mapping and navigation; software development and lifecycle management; virtual classroom education delivery; data analytics processing; transaction processing; and revalidation processing.

Thus, in certain embodiments, software or a program, implementing revalidation processing in accordance with embodiments described herein, is provided as a service in a cloud environment.

In certain embodiments, the computing device 100 has the architecture of computing node 410. In certain embodiments, the computing device 100 is part of a cloud environment. In certain alternative embodiments, the computing device 100 is not part of a cloud environment.

### Additional Embodiment Details

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method, comprising:
in response to one or more triggers,
estimating, using a processor of a computer, an amount of time that it would take to update an item and a return on investment of updating the item based on historical data for similar updates that have been made to at least one of the item and another item; and
determining whether to update the item based on the estimated amount of time and the estimated return on investment.

2. The computer-implemented method of claim 1, wherein the item comprises at least one of a document, a video, an audio, a web page, and a blog.

3. The computer-implemented method of claim 1, further comprising:
in response to determining that the item is to be updated, notifying a user to update the item.

4. The computer-implemented method of claim 1, further comprising:
in response to determining that the item is to be updated, updating the item.

5. The computer-implemented method of claim 4, further comprising:
in response to determining that the item is to be updated, identifying another, similar item to be updated.

6. The computer-implemented method of claim 1, wherein it is determined to update the item when the return on investment exceeds a threshold.

7. The computer-implemented method of claim 1, wherein software is provided as a service in a cloud environment.

8-20. (canceled)
